(19) United States
(12) Patent Application Publication
(10) Pub. No.: US 2013/0209728 A1
(43) Pub. Date: Aug. 15, 2013

(54) ROD WINDING STRUCTURE IN COMPOSITE DESIGN

(71) Applicant: Dirk Buechler, Guestrow (DE)

(72) Inventor: Dirk Buechler, Guestrow (DE)

(73) Assignee: BALTICO GMBH, Hohen Luckow (DE)

(21) Appl. No.: 13/812,945

(22) PCT Filed: Jul. 29, 2011
(86) PCT No.: PCT/EP2011/063080

§ 371 Date: Apr. 12, 2013

(30) Foreign Application Priority Data
Jul. 30, 2010 (DE) 10 2010 038 719.3

(51) Int. Cl. B32B 3/26; F03D 1/06

(52) U.S. Cl. CPC B32B 3/263; F03D 1/0675
USPC 428/99; 416/233; 428/156

(57) ABSTRACT

A complex, three-dimensional lattice made of previously impregnated fiber strands is laid over nodes, thus forming the main body of the component to be produced. The composite wound rod structure, comprising a skeleton of ribs that are formed of impregnated fiber strands in a continuous winding and laying process, is characterized in that the ribs are solid ribs, or lattice structure ribs prefabricated from fiber strands, which contain nodes, over which the impregnated fiber strands are alternately, and incrementally, placed diagonally, horizontally and vertically, until the desired strand thickness has been reached, and the wound rod structure can be segmented as needed. The solid ribs are made of fiber composites, aluminum, or other lightweight materials.

### BACKGROUND OF THE INVENTION

The invention relates to composite wound rod structures, which can be used, among other things, for airfoils or rotor blades, for example, but also in other areas in which a lightweight structure is sought, for example for hulls, car bodies, support structures for solar reflector panels, and the like.

Stressed skin designs are typically employed in the production of airfoils and rotors used in airplane construction, or for wind power plants (namely, wind turbines), for example, or in the construction of boats. To this end, the outer surface is generally stressed around a generally centrally located spar so as to form the shell. The skin can absorb a significant amount of the forces.

This type of construction has a drawback in that the implementation thereof requires significant manual effort. For example, all the individual elements must be cut to size, positioned, and ultimately joined. This makes reproducibility more complicated, and the manufacturing costs are high.

In addition, the skin thicknesses can only be optimized to a limited extent because, otherwise, the technological complexity would grow excessively. The weight is consequently not optimal.

Connections and unions, in particular with metallic structural elements, or in the case of segments, also among each other, are possible only to a limited extent and are complex. It is also complicated to join additional components.

A deliberate imparted functionality, such as load-dependent torsion of the components, is only possible with a wide range of restrictions.

The solution described in WO 2008/115265 A1 promises an alternative. A number of mutually spaced profiled parts, which form the profile shape, are held together in the manner of a truss structure by a variety of spars and cross members made of pultruded fiberglass sections.

However, the technological complexity is also significant here because the individual parts must be cut to size manually, positioned and joined, and this is not very conducive to industrial production.

Production by way of wound rod structures according to the patent DE 102006038130 B3 offers an alternative. Here, a method for producing supporting structures and the supporting structure produced therewith are disclosed. Impregnated carbon fiber strands are horizontally, vertically and diagonally wound around attachment parts, which are arranged in a grid, using a single continuous winding and laying method. If no attachment parts are used, the impregnated carbon fiber strands can be laid above and beneath previously wound or laid carbon fiber strands. This creates a lattice grid, which is very stable and has a high load-bearing capacity. The use for airfoils and rotors, hulls, car bodies and support structures for solar reflector panels is not provided for here.

### SUMMARY OF THE INVENTION

Proceeding from the prior art, it is the object of the invention to further develop wound rod structures so that these are also suited for the production of airfoils, or rotor blades or in other areas in which a lightweight structure is sought, for example, for watercraft hulls, deck superstructures, support structures for solar panels, and the like.

According to the invention, a complex, three-dimensional lattice made of previously impregnated fiber strands is laid over nodes, thus forming the main body of the component to be produced.

The composite wound rod structure, comprising a skeleton of ribs that are formed of impregnated fiber strands in a continuous winding and laying process, is characterized in that the ribs are solid ribs, or lattice structure ribs prefabricated from fiber strands, which contain nodes, over which the impregnated fiber strands are alternately, and incrementally, placed diagonally, horizontally and vertically, until the desired strand thickness has been reached, and the wound rod structure can be segmented as needed. The solid ribs are made of fiber composites, aluminum, or other lightweight materials.

The shapes of the ribs are based on the outer profile of the wound rod structure, and the wound rod structure is divided into sections by the ribs, wherein the distances between the ribs are dependent on the overall structure and the requirement thereof in terms of strength.

In one embodiment, the nodes are mutually opposing openings, which are directed toward the outer edges of the ribs, and which are uniformly distributed over the entire rib, and have a diameter that is dependent on the final thickness of the fiber strands to be inserted, wherein the opening widths of the nodes are smaller toward the outside than the final fiber strand cross-section to be expected.

In another embodiment attachment parts are preferred, which are arranged on the ribs as nodes. The attachment parts are concave, cylindrical parts having a beaded edge, or an edge that is thickened in another manner. They are provided with a central bore, or designed as hollow cylindrical parts. For example, they can be made of aluminum. After the production process, the attachment parts can be removed from the component, or remain in the component as an additional supporting structure.

In an additional embodiment, the ribs are designed as profiled flanges in that a groove extends on the outer sides thereof between two respective openings, or attachment parts, with the fiber strands being inserted in this groove. Two ribs can thus be connected to each other, whereby an overall structure is formed. The connection is established by way of a screw assembly of the profiled flanges.

A metal flange, which has threaded pins that are distributed over the circumference and located transversely to the fiber strands to be wound, is arranged in the base region of the wound rod structure.

The entire structure is covered by wrapping, planking, or a covering formed by casting or foaming.

The wound rod structure according to the invention can be used as a rotor blade for wind power plants, or as an airfoil for airplanes or hydrofoil for ships.

The production process itself can be automated and carried out by handling robots. After completion of the production process, the material is cured and forms the skeleton for strength. By incorporating bushings and/or pins, preferably made of metal, during the winding process, an excellent bond can be established with other components/attachments.

The resulting supporting framework structure can be covered with planks in a subsequent operation, or covered with foam in a mold using a foamed material. This creates the desired geometry and surface quality. So as to increase the abrasion resistance, or for decorative purposes, a coating using foil or paint can be further applied.

The invention will be described in more detail with reference to the drawings. In the drawings:

### BRIEF DESCRIPTION OF THE DRAWINGS

FIG. 1 is a schematic illustration of an exemplary embodiment of the invention as a rotor blade with the composite wound rod structure;

FIG. 2 shows solid ribs comprising a wrapping made of fiber strands;

FIG. 3 shows a solid rib comprising grooves and openings;

FIG. 4 shows a connection of the ribs with each other using a profile flange-like screw assembly;

FIG. 5 shows a connection to a metal flange in the base region of the rotor blade (schematic illustration);

FIG. 6 shows a connection to a metal flange in the base region of a rotor blade comprising solid ribs;

FIG. 7 shows a connection to a metal flange in the base region of a rotor blade, comprising lattice structure ribs that are wound and prefabricated from fiber strands;

FIG. 8 shows a rotor blade (detail) comprising a shell-shaped foam covering to provide the outer contour and sealing;

FIG. 9 shows a hull in the supporting framework structure;

FIG. 10 shows a deck house in the supporting framework structure; and

FIG. 11 shows a support structure for a solar reflector panel.

### DETAILED DESCRIPTION OF THE INVENTION

The solution according to the invention can be employed wherever lightweight structural parts are required. The invention will be described based on a rotor blade for wind power plants as an exemplary embodiment. However, it is also conceivable, for example, to produce airfoils for airplanes according to the same principle.

According to the invention, a complex, three-dimensional lattice made of previously impregnated fiber strands, for example carbon fibers or glass fibers, is laid over nodes, thus forming the main body of the component to be produced. Nodes denotes the points on the ribs at which several fiber bundles converge. For example, the nodes can be formed directly in the ribs by openings that are open to the outside.

Other nodes can be formed of attachment parts which are designed as concave, cylindrical parts having a beaded edge, or an edge that is thickened in another manner. The cylindrical parts can be provided with a central bore, or designed as hollow cylindrical parts. The preferred material is aluminum, however other materials that are lightweight, yet have good load-bearing capacity, are also conceivable.

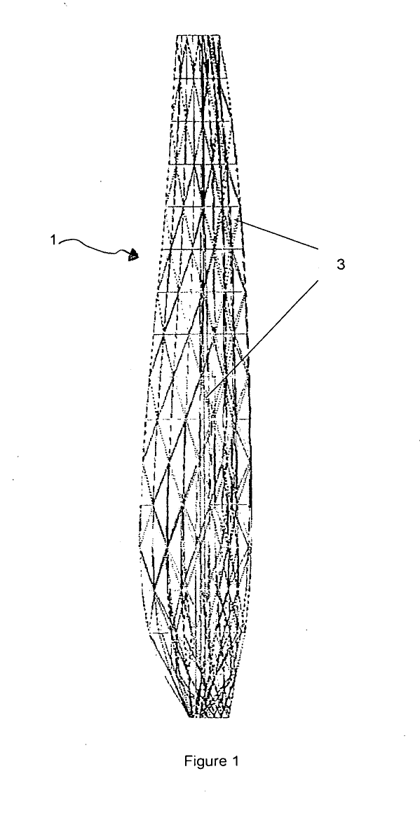

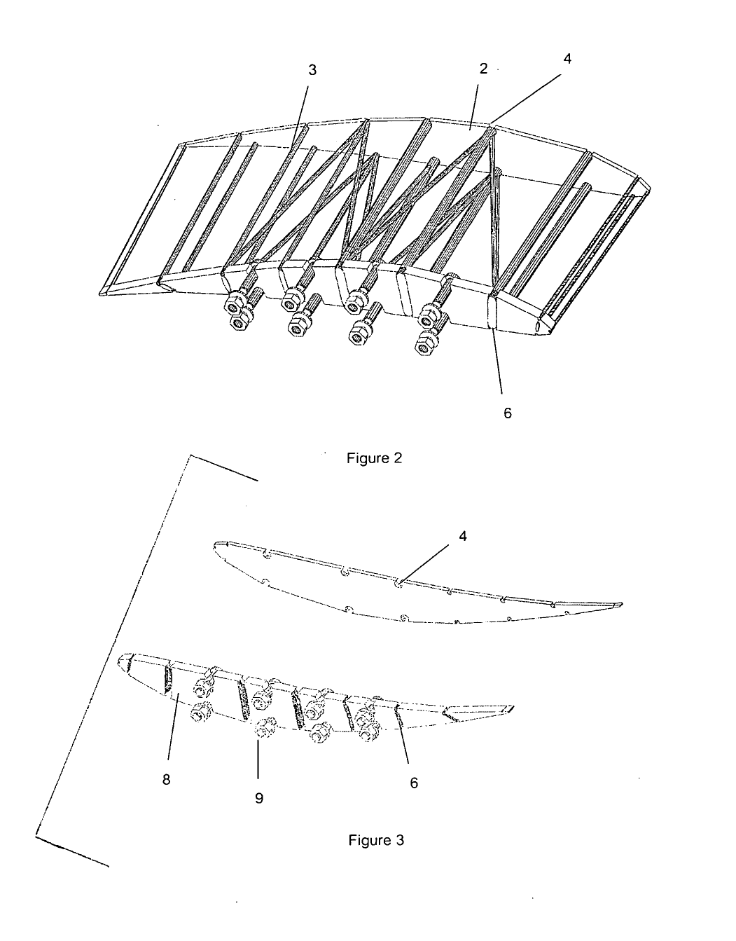

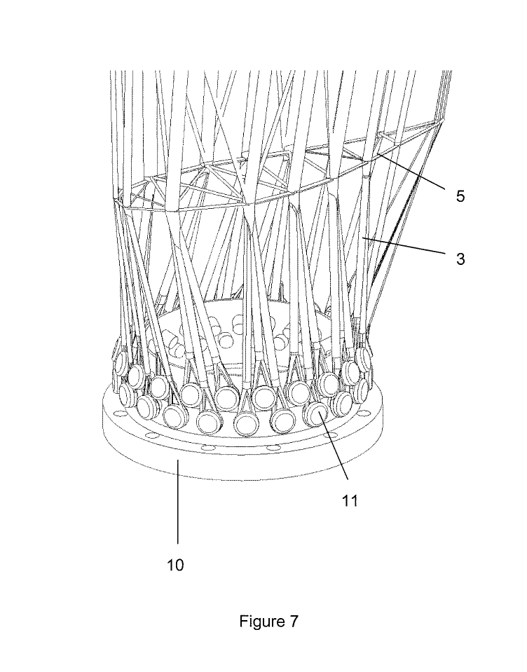

The shape of the rotor blade 1 in FIG. 1 is formed of a skeleton of ribs made of solid ribs 2 (FIG. 2), or made of lattice structure ribs 5 that are wound and likewise prefabricated from impregnated fiber strands (refer to FIG. 7). The material of the solid ribs 2 can be varied. Both fiber composites and aluminum, or other lightweight materials, are conceivable. The shapes of the ribs are based on the outer profile of the rotor blade 1. The ribs divide the rotor blade 1 into sections.

The ribs have mutually opposing openings 4 (nodes), which are directed toward the outer edges and here are uniformly distributed over the entire rib. The distances between the nodes can also vary. The opening 4 has a previously calculated diameter, which is dependent on the final thickness of the fiber strands 3 to be inserted. The opening widths of the nodes 4 are smaller toward the outside than the final fiber strand cross-section to be expected.

As an alternative, attachment parts (not shown), which, after the production process, can be removed from the component, or remain in the component as an additional supporting structure, may be arranged as nodes on the ribs.

Impregnated fiber strands 3 are alternately, and incrementally, placed diagonally, horizontally and vertically in the openings 4, or over the attachment parts 7, in a continuous winding and laying process between the ribs, which are arranged at defined distances from each other and which are calculated based on the total length of the rotor blade and the required strength (in the example between 10 cm and 500 cm). The placement takes place distributed over the individual nodes until the desired strand thickness has been reached. The chronological order of placing the fiber strands 3 is calculated so that a substantially continuous process is carried out over all nodes. The distances between the individual ribs can differ as a result of the design.

If the rotor blade 1 is to be segmented, for example so as to avoid transportation problems, a profiled flange 8 can be inserted as a rib at the ends to be connected in a targeted manner. This is shown in FIG. 3. A groove 6 extends on the outer side of the profiled flange 8 between two respective openings 4, or attachment parts 7. Because of the groove 6, the fiber strands 3 are not seated on the surface, but end flush with the surface of the profiled flange 8, so that two ribs can be joined with no intermediate space.

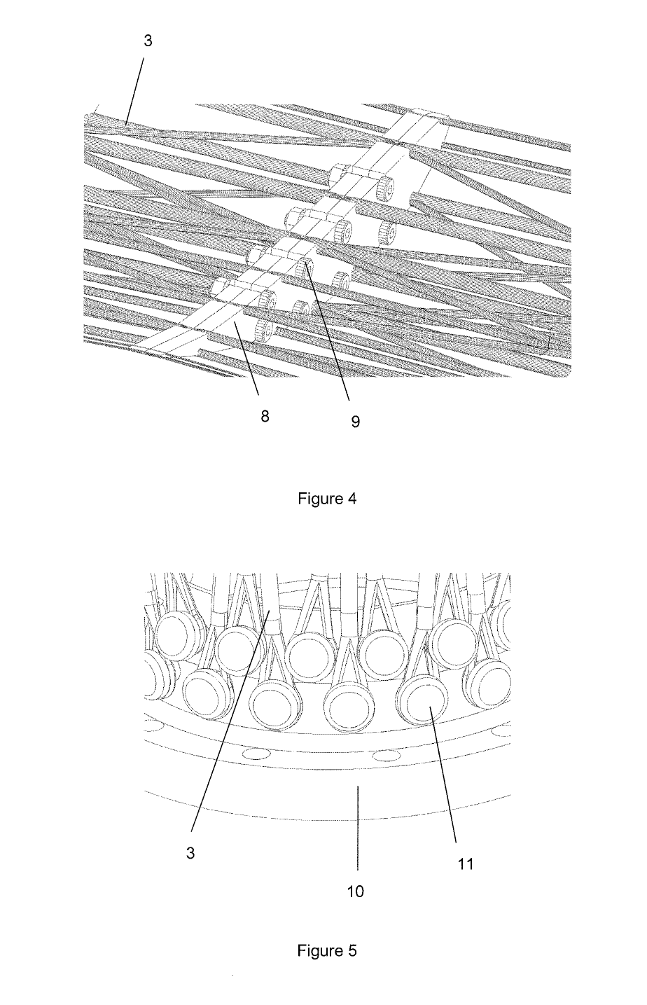

The individual sections of the rotor blade 1 are connected with each other by way of a screw assembly 9 of the profiled flanges 8 (FIG. 4). The individual longitudinal fiber strands 3 are returned around the profiled flange 8 and surround the same. The fiber strands 3 are recessed in the flange on the contact surface with the mating flange and, thus, allow the two flange halves to be seated on each other in a planar manner. Because of this design, it is also conceivable to configure the construction so that the ribs are replaceable.

FIG. 5 is a schematic illustration of a connection to a metal flange 10 in the base region of the rotor blade 1. The metal flange 10 constitutes a special form of a rib. The shape of the metal flange 10 is designed in keeping with the use. It is generally circular in a rotor blade 1 for wind power plants. However, different cross-sections can also be produced. The metal flange 10 comprises threaded pins 11 that are distributed over the circumference and located transversely relative to the fiber strands 3 to be wound. The fiber strands 3 are laid around these threaded pins 11. In this way, a very uniform connection with high load-bearing capacity is achieved.

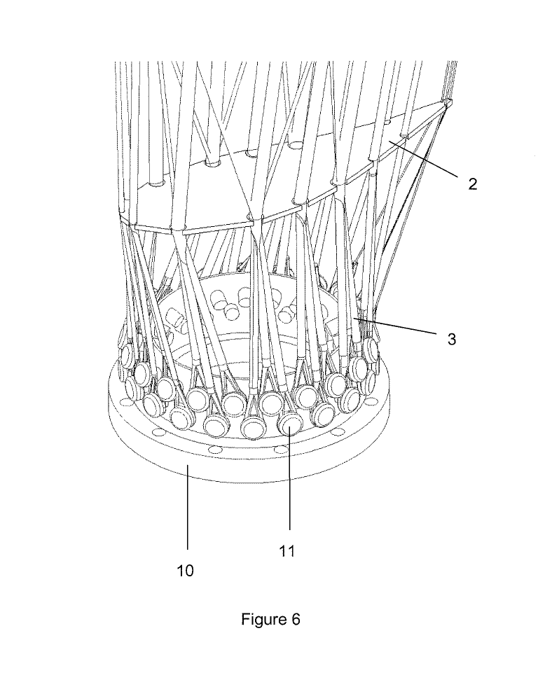

FIG. 6 shows the connection to a metal flange 10 in the base region of a rotor blade 1, comprising solid ribs 2, as one embodiment, and FIG. 7 shows the connection to a metal flange 10 in the base region of the rotor blade 1, comprising lattice structure ribs 5 that are wound and prefabricated from carbon fiber strands, as a second embodiment.

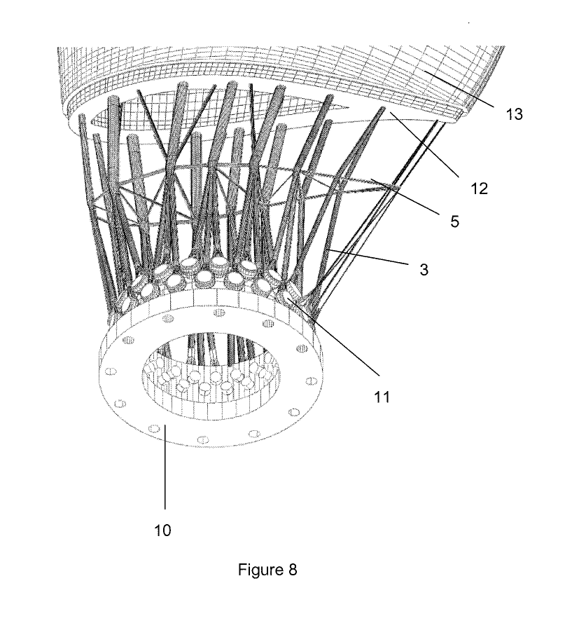

Finally, as shown in FIG. 8, the entire lattice structure, or parts of the structure, are covered by a foam, or a plastic material potted or filled with foam. It is also possible to combine several techniques. The foam covering 12 can completely fill in the construction, or be designed in a shell shape to form the outer contour. Sealing or covering 13 can be provided on the outer surface by way of a weather and erosion resistant film. However, as an alternative, it is also possible to use a composite laminate, or a metallic surface plank covering.

If the construction is to be used as an airfoil for airplanes, or a hydrofoil for ships, for example (such as ground effect vehicles, hydroplanes), only the shapes of the ribs and the distances from each other change. The basic construction is thus similar and does not require any detailed description.

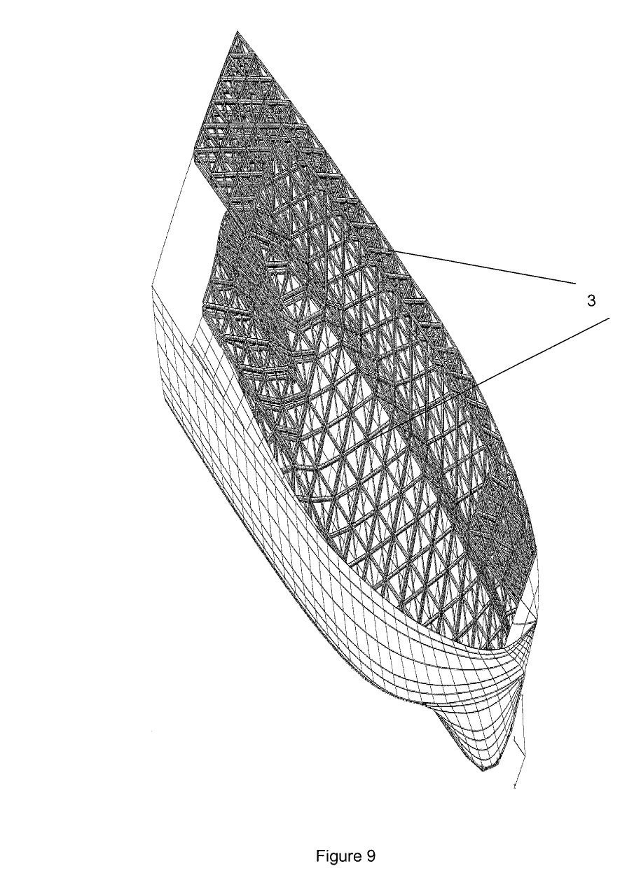

FIGS. 9 to 11 show additional examples of possible applications. With the invention it is even possible to produce complicated supporting framework structures such as for a hull (FIG. 9) or a car body, railway cars and engine trolleys, or fuselages. For a hull according to FIG. 9, the fiber strands 3 are placed into openings on ribs that are distributed over the hull length, the openings not being shown here, but described in FIG. 2. The outer skin is glued to the lattice structure to form a laminate. The ribs themselves can remain in the structure or be designed as reusable tools.

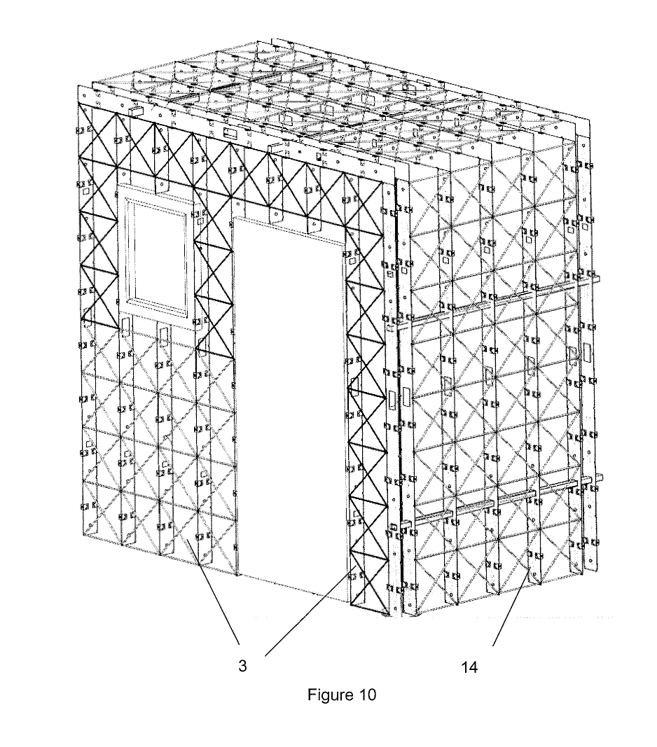

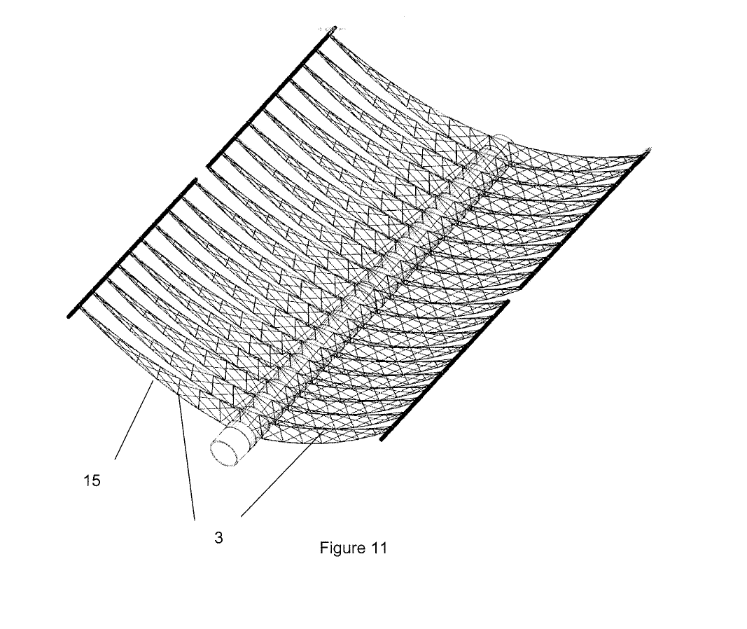

FIG. 10 shows a deck house, which can be produced in the same manner. Advantageously, individual wall elements, such as the longitudinal side/transverse side or ceiling, should be produced separately and the ribs 14 should remain in the component. The ribs 14 can also be designed as a wound structure.

The deck house in FIG. 10, as well as the support structure for solar reflector panels (FIG. 11), are additional examples of possible implementations. For the solar reflector panel (FIG. 11), the structure is made of lattice components (ribs 15) that are previously wound in a planar manner. These are pushed on profiled sections (tubes here) centrally and on the outside and glued on. Metal pipes, or pultruded plastic tubes are used as the profiled sections.

The above applications of the invention shall not be considered exhaustive; potential other applications can be found in all fields of technology.

1-17. (canceled)

18. A composite wound rod structure, comprising a first set of impregnated fiber strands that are wound and laid by a continuous process so as to be alternately and incrementally diagonal, horizontal and vertical, the process being carried out until a desired strand thickness has been reached, and a skeleton of ribs having nodes integrally formed thereon or having attachment parts forming nodes, wherein the ribs are solid ribs or lattice structure ribs prefabricated from a second set of impregnated fiber strands, the nodes forming mutually opposed sites for retaining the fiber strands of the first set on outer edges of the ribs and being uniformly distributed over each entire rib, the openings being of sufficient diameter to receive the fiber strands of the first set and being constricted to a diameter less than that of the fiber strands of the first set immediately proximate to the outer edge of the rib so as to retain the fiber strands of the first set in the openings.

19. The wound rod structure according to claim 18, wherein the shapes of the ribs are based on an outer profile of the wound rod structure, and the wound rod structure is divided into sections by the ribs, wherein distances between the ribs are dependent on an overall structure and a strength requirement.

20. The wound rod structure according to claim 19, wherein the solid ribs are made of fiber composites, or aluminum, or other lightweight material.

21. The wound rod structure according to claim 18, wherein the nodes are formed by attachment parts arranged on the ribs.

22. The wound rod according to claim 21, wherein the attachment parts are concave, cylindrical parts having a beaded edge or an edge that is thickened in configuration other than beaded.

23. The wound rod according to claim 21, wherein the attachment parts are each provided with a central bore, or are in a form of a hollow cylinder.

24. The wound rod according to claim 21, wherein the attachment parts are eventually removed when no longer needed for structural integrity or remain in the component as an additional supporting structure.

25. A wound rod according to claim 18, wherein ribs are formed as profiled flanges with a groove extending on outer sides thereof between two respective openings or attachment parts, with the fiber strands of the first set being inserted into the groove.

26. The wound rod structure according to claim 25, wherein two of the ribs are fixedly or releasably connected to each other.

27. The wound rod structure according to claim 21, wherein the two ribs are connected to each other by a screw assembly.

28. The wound rod structure according to claim 18, wherein a metal flange which has threaded pins distributed over a circumference thereof and located transversely to the fiber strands of the first set, is arranged in a base region of the wound rod structure.

29. The wound rod structure according to claim 28, wherein the metal flange is circular.

30. The wound rod structure according to claim 18, wherein overall structure of the composite rod structure is covered by wrapping, planking or a covering formed by casting or foaming.

31. A rotor blade for a wind turbine or an airfoil for an aircraft or a hydrofoil for a watercraft, comprising the rod structure of claim 18.
